(19) United States
(12) Patent Application Publication
(10) Pub. No.: US 2008/0073949 A1
(43) Pub. Date: Mar. 27, 2008

(54) Remote Control Embedded in Furniture

(76) Inventor: Dario Rozman, Meggen (CH)

Correspondence Address: JONATHAN M. ZWEIG, 899 S. TANTAU AVE, CUPERTINO, CA, 95014, US

(21) Appl. No.: 11/309,787

(22) Filed: Sep. 27, 2006

(51) Int. Cl. G08C 19/12; H04B 10/00; H04L 17/02

(52) U.S. Cl. 297/188.14; 340/870.28; 341/176; 398/106

(57) ABSTRACT

As described in U.S. Pat. No. D436,747 owned by Earl J Wiley and Paula Wiley of 820 Oakside La., University Park, Ill. (US) 60466, one type of a chair has been proposed with a built-in remote control. The problem with that design is that it indicates one transceiver. Depending on how the user is sitting in the chair or the layout of the room, this could impede the transceiver signal. For example, if the user is sitting with his feet up, he might block the signal for the device which should be controlled. Therefore, transceivers on both front sides are necessary to ensure reliable performance. Another case could be that the user wants to control devices behind him without turning the chair around. In this case the user can, with this invention, control the device with the transceivers which are built in the back of the chair. Thus, there is a significant improvement of this invention in controlling, operating, accessing or manipulating home electronic devices, home appliances and computers (Desktop, Media Centers and Laptops). Another improvement of this design of the embedded remote control is the armrest. It enables the user immediate access to the remote control without having to lift up a lid. This improves the comfort and the user-friendliness of the overall experience. Finally, easy access to the battery compartment and the option of permanently enclosing the user input device (separate from the power supply) improves ease of maintenance.

This invention overcomes functional limitations that limit the usefulness of a remote control that is imbedded in a piece of furniture. By providing multiple infrared or radio transceivers, the need to reposition the furniture in order to operate the remote control is eliminated. By placing the batteries or other power supply for the remote control in a separate compartment, the ease of accessing the batteries for replacement is increased.

A conventional handheld cordless remote control typically consists of a user input device (most often, a set of buttons) coupled to a transceiver (such as an infrared light-emitting diode) that sends a signal (most commonly a series of pulses) to a remote device (such as a television, audio amplifier, radio, DVD player, or the like) when the user inputs a command (typically by pressing a button). The power supply (usually in the form of batteries) is contained within the unit. In order to ensure that the signal is received by the controlled device, the user points the remote control at that device before pressing the button.

When embedding a remote control in a piece of furniture, it becomes apparent that moving the remote control so that it points toward the controlled device is not always convenient for a user. A sofa, for example, is typically very difficult to move. A chair is more easily moved, but this can be inconvenient for the user. Therefore, a technique that allows the remote control to transmit signals to a controlled device without being repositioned or aimed is desirable. It is also apparent that accessing the battery compartment of a remote control that is embedded (for example, sewn into the upholstery of a sofa) can be difficult. So placing the battery compartment in a more-easily accessible part of the piece of furniture is desirable.

An important aspect of the way the transceivers are located in the armrest is that it enables the user to operate devices in a 360 degree radius. The remote control which is embedded in the armrest is wired to the two transceivers mounted on the front as well as the two transceivers mounted to the back side of the chair.

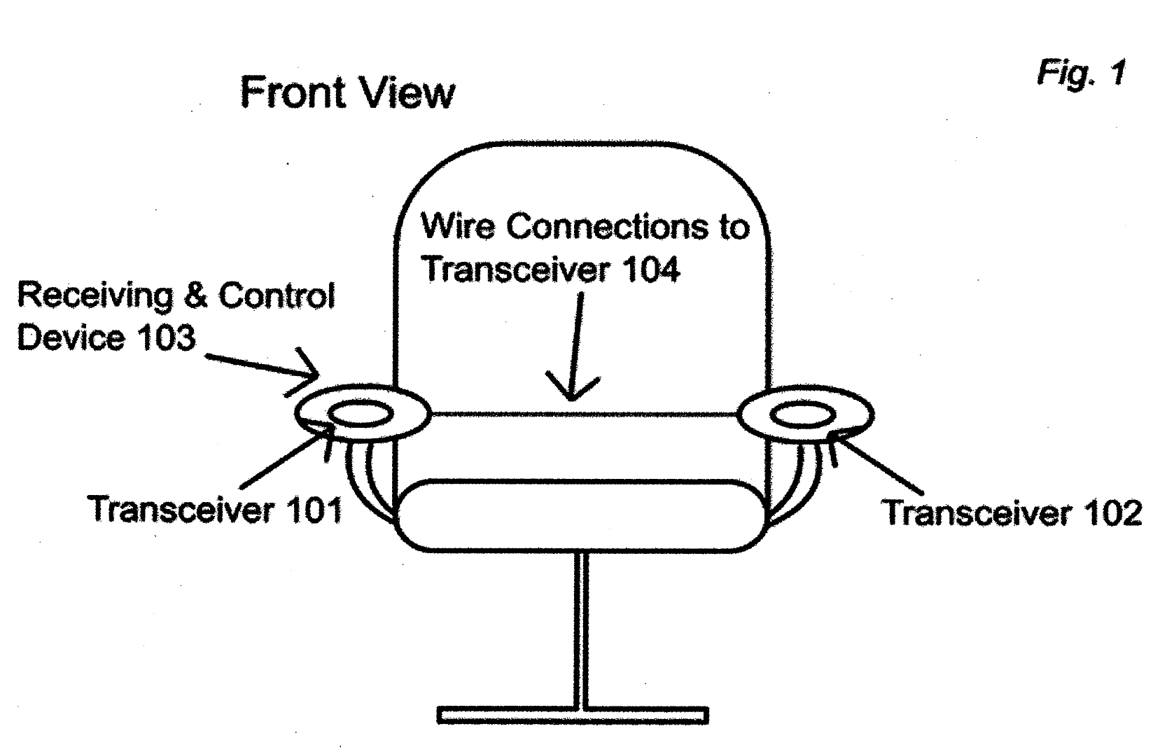

Referring to the attached drawings, FIG. 1 illustrates a front-view of the embedded remote control as embodied in a chair. Transceivers 101 and 102 will typically both transmit the same signal, in response to input from user input device 103. These and other components of the system are interconnected by wires (as exemplified by wire 104) that are embedded within the upholstery of the piece of furniture. In the event that user input and control device 103 is a “universal” or “learning” remote control device, there may additionally be a receiver for detecting the signal from an external remote control device that is part of control device 103, either or both or the transceivers 110 or 102, or elsewhere within the piece of furniture.

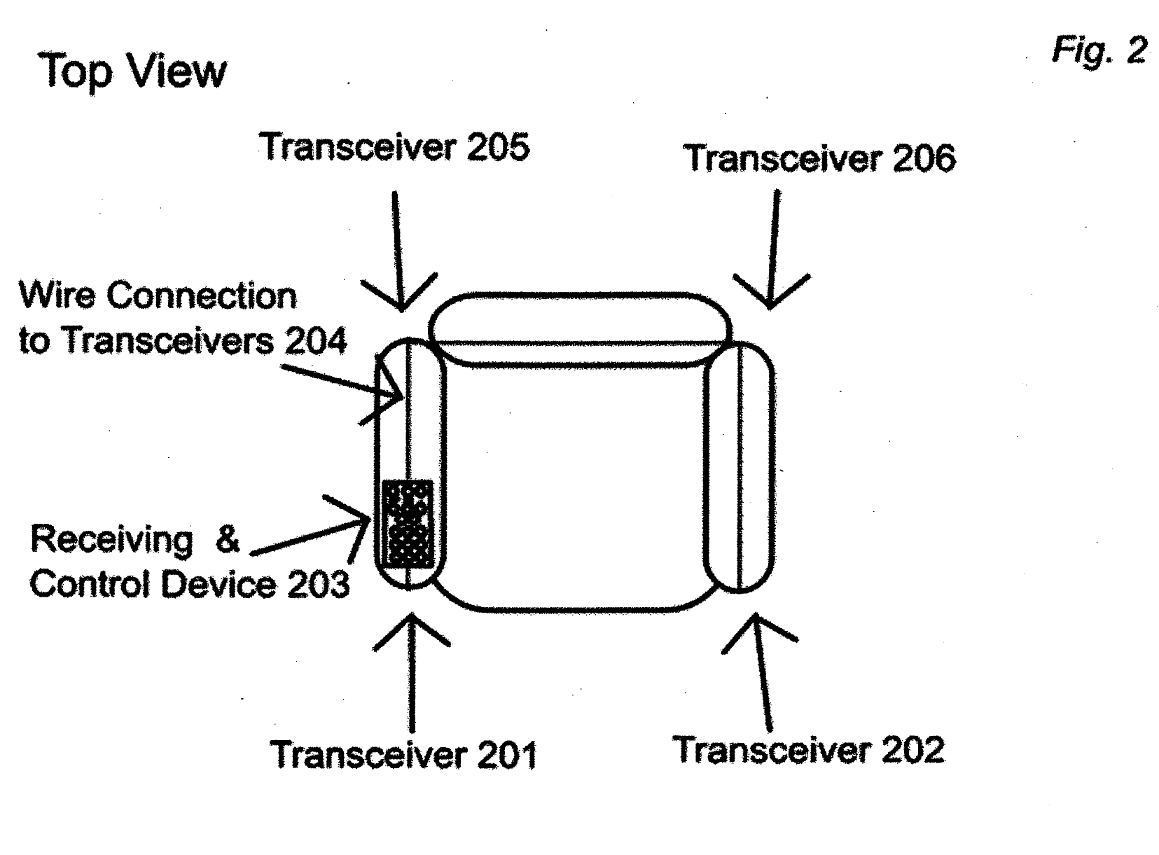

FIG. 2 illustrates the remote control 203 which is embedded in the armrest of a chair (top view). Further, it shows the wire connections (204 for example) between transceivers 201, 202, 205 and 206 and the user input and control device 203. The transceivers in this example are mounted on the left and right and front and back sides of the chair.

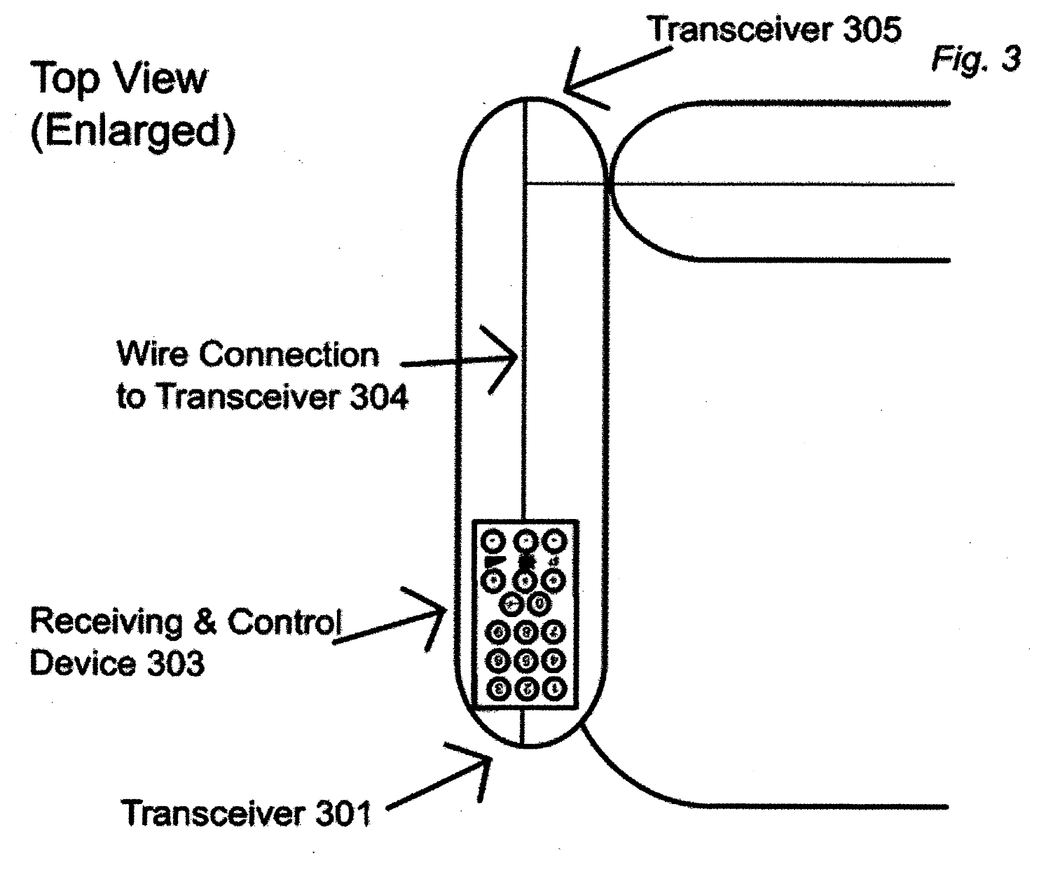

FIG. 3 illustrates an enlarged view of the embedded remote control 303 and the wire connections (for example, wire 304) to transceivers 301 and 305 on the right side in front and back.

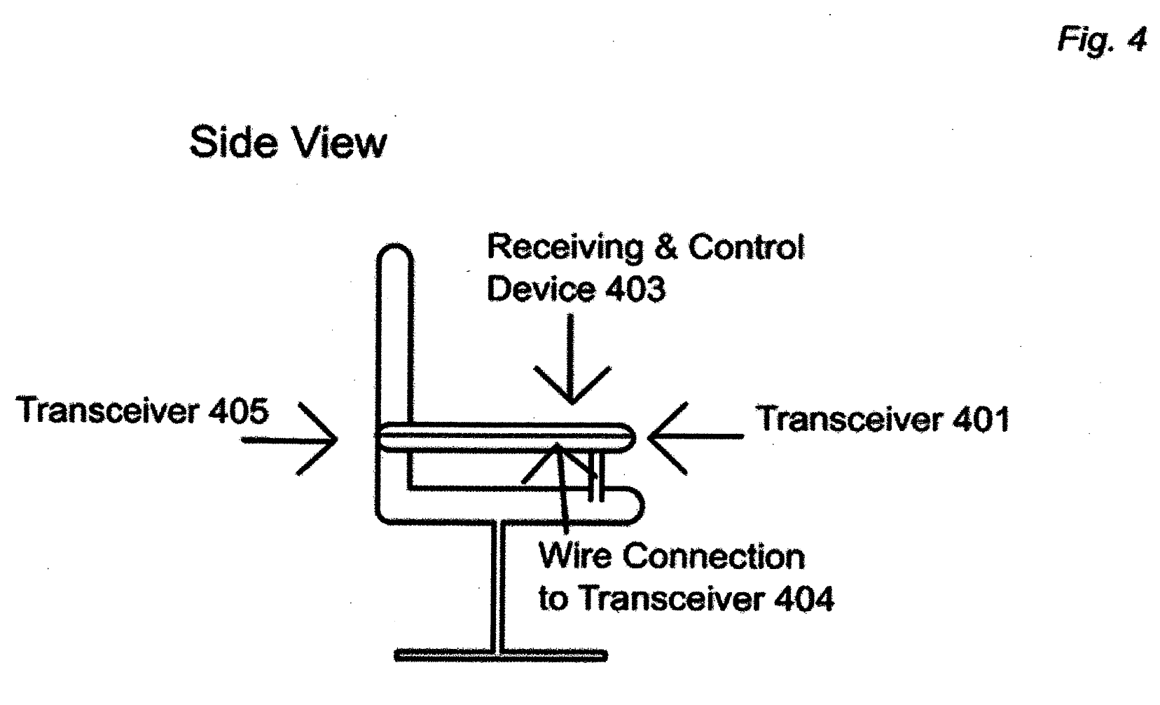

FIG. 4 illustrates a side view of the embedded remote control consisting of controller 403, wire connection 404 as well as transceivers 401 and 405 on the right side in front and back.

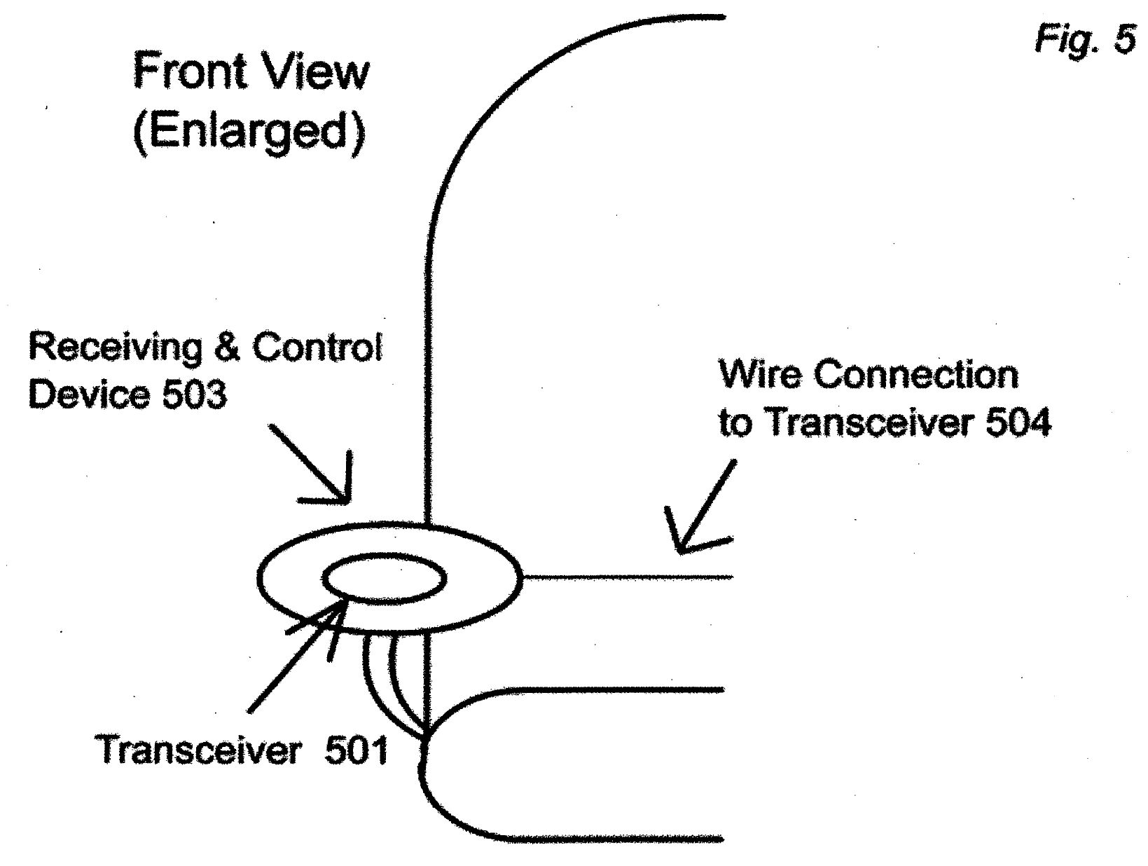

FIG. 5 illustrates an enlarged view of the embedded remote control consisting of user input and control device 503, transceiver 501, as well as the wire connections to the various other transceivers on the right and left side in front and back.

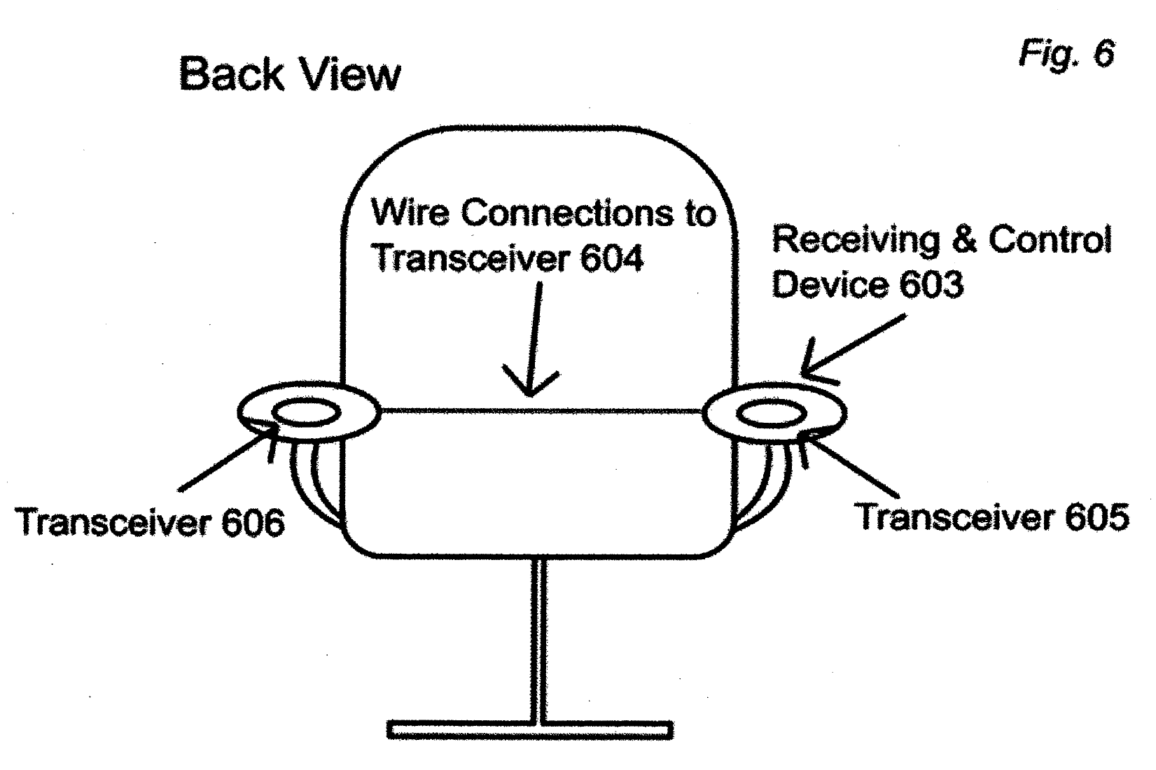

FIG. 6 illustrates a back view of the embedded remote control consisting of user input and control device, wire connections 604 (et al) as well as the transceivers 605 on the right side and transceiver 606 on the left side in the back.

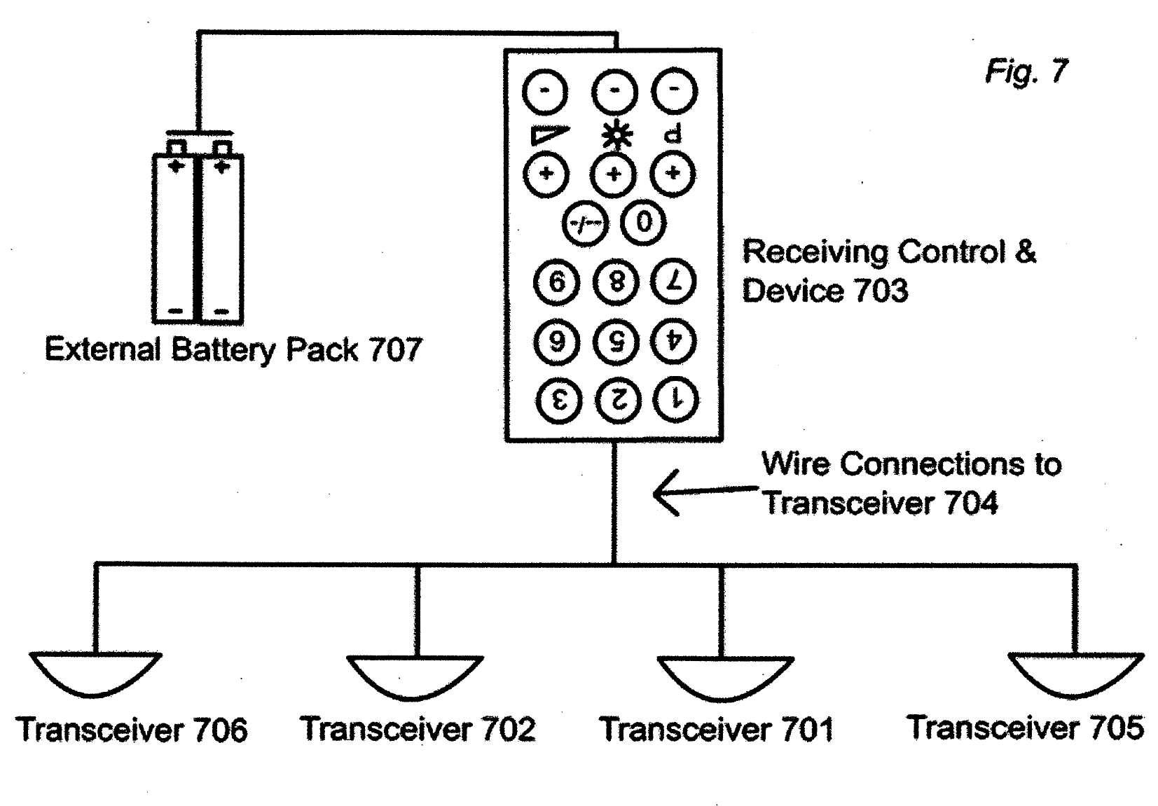

FIG. 7 illustrates a remote control device before the installation in the chair. The remote control consists of user input and control device 703, connected via wires 704 to the various transceivers (701, 702, 705, 706) which will be embedded, as illustrated in FIGS. 1-6, in the arm, as well as the front and back side of the chair. It also shows an external battery pack 707 which may be embedded in the piece of furniture in a separate location.

The implementation here is presented for explanatory purposes. Other configurations and details of connection, setup, operation, and maintenance of the embedded remote control will be apparent to one of ordinary skill in the art.

What is claimed is:

1. A remote control embedded in or designed to be embedded in a piece of furniture, comprising a power source, user input device, and two or more control channel transceivers.

2. A remote control according to [claim 1] using infrared transmitters as the control channel transceivers.

3. A remote control according to [claim 1] using radio transmitters as the control channel transceivers.

4. A remote control according to [claim 1] using bidirectional infrared transmitter/receivers as the control channel transceivers.

5. A remote control according to [claim 1] using bidirectional radio transmitter/receivers as the control channel transceivers.

6. A remote control according to [claim 1] that is embedded in, or designed to be imbedded in a chair.

7. A remote control according to [claim 1] that is embedded in, or designed to be imbedded in a couch or sofa.

8. A remote control according to [claim 1] that is embedded in, or designed to be imbedded in a wheelchair or motorized scooter.

9. A remote control embedded in or designed to be embedded in a piece of furniture, comprising a power source that is physically separated from the user input device by means of a wire.

10. A remote control according to [claim 9] that is embedded in, or designed to be imbedded in a chair.

11. A remote control according to [claim 9] that is embedded in, or designed to be imbedded in a couch or sofa.

12. A remote control according to [claim 9] that is embedded in, or designed to be imbedded in a wheelchair or motorized scooter.

13. A remote control embedded in or designed to be embedded in a piece of furniture, comprising a power source, user input device, and one or more control channel transceivers that are physically separated from the user input device by means of a wire.

14. A remote control according to [claim 13] that is embedded in, or designed to be imbedded in a chair.

15. A remote control according to [claim 13] that is embedded in, or designed to be imbedded in a couch or sofa.

16. A remote control according to [claim 13] that is embedded in, or designed to be imbedded in a wheelchair or motorized scooter.
